(19) United States
(12) Patent Application Publication
(10) Pub. No.: US 2024/0237661 A1
(43) Pub. Date: Jul. 18, 2024

(54) ANTIMICROBIAL SOLUTIONS AND USES THEREOF

(71) Applicant: EcoPlanet Environmental LLC, Belgrade, MT (US)

(72) Inventors: Gary A. STROBEL, Bozeman, MT (US); Bryan BLATT, Manhattan, MT (US)

(21) Appl. No.: 18/415,537

(22) Filed: Jan. 17, 2024

Related U.S. Application Data
(60) Provisional application No. 63/480,272, filed on Jan. 17, 2023.
(60) Provisional application No. 63/493,715, filed on Mar. 31, 2023.
(60) Provisional application No. 63/598,428, filed on Nov. 13, 2023.

(51) Int. Cl. A23B 4/20; A01N 37/02; A01N 57/12; A01P 1/00; A23L 3/3517; A23L 3/3553

(52) U.S. Cl. CPC A23B 4/20; A01N 37/02; A01N 57/12; A01P 1/00; A23L 3/3517; A23L 3/3553

(57) ABSTRACT

The compositions described herein comprise isoamyl hexanoates, and at least one organic acid component. These compositions are useful for reducing odors. Another form of the composition, further comprising at least one additional ingredient selected from: lecithin, and peracetic acid, is useful for reducing microbial contamination of raw animal tissue. The at least one acid may be lactic acid, propionic acid, isobutyric acid, butyric acid, formic acid, acetic acid, citric acid, oxalic acid, uric acid, malic acid, tartaric acid, or combinations thereof. The compositions may be provided in any suitable form depending largely on the intended use or mode of application test.

### RELATED APPLICATIONS

This application claims priority to and the benefit of U.S. Provisional Patent Application No. 63/480,272, filed Jan. 17, 2023 titled “A COMPOSITION FOR REDUCING THE SALMONELLA ENTERICA SEROVAR TYPHIMURIUM CONTAMINATION OF BROILER CARCASSES IN A WING WASH MODEL”, U.S. Provisional Patent Application No. 63/493,715, filed Mar. 31, 2023 titled “COMPOSITION FOR REDUCING THE SALMONELLA ENTERICA SEROVAR TYPHIMURIUM CONTAMINATION OF BROILER CARCASSES IN A WING WASH MODEL”, and U.S. Provisional Patent Application No. 63/598,428, filed Nov. 13, 2023, titled “NOVELTY ANTIMICROBIAL SOLUTIONS THAT SOLVE HUMAN AND ANIMAL HEALTH CHALLENGES,” the entirety of the disclosures of which are hereby incorporated by these references.

### TECHNICAL FIELD

The disclosure of the present patent application relates to the treatment of infections, including bacterial, fungal, parasitic, protozoan, and viral infections, and particularly to a composition including isoamyl hexanoates and at least one acid, such as lactic acid, propionic acid, isobutyric acid, butyric acid, formic acid, acetic acid, citric acid, oxalic acid, uric acid, malic acid, tartaric acid or combinations thereof.

The composition may be incorporated into a human or animal food or food supplement, and particularly may be used in the form of, for example, an animal feed composition, to provide a supplement for treating infections, including bacterial, fungal, parasitic, protozoan and viral infections, and that improves gut health, may be used for weight gain, may be used as an immune modulator, and may further be used as a feed preservative.

The composition may also be in a form useful for decontaminating animal tissue being prepared or processed for consumption as human food products. The composition may further be in a useful for deodorizing animal waste or housing environment. The composition could be administered directly to waste, or, for example, to litter (such as cat litter), or to bedding of the animal or human.

### BACKGROUND

Due to the ability of microorganisms to evolve and adapt to antimicrobial agents, there is a constant need for new treatments for infections of all types. There is a particular need for broad spectrum treatments which can be used to treat a wide variety of conditions. Among the benefits from broad spectrum treatments, are the reduction on the overreliance on antibiotics which has led to a worldwide problem of antibiotic resistance as well as a different mode of action than antibiotics. Unfortunately, such broad-spectrum treatments are not only rare, but they are also very difficult and expensive to manufacture. Further, such treatments are typically limited in how they may be administered. For example, an oral treatment may not be able to be adapted into a topical treatment, or a topical treatment may not be able to be adapted for oral usage.

It would be desirable to be able to provide a single broad-spectrum agent which can be adapted to application in a wide variety of different ways, including adaptation for oral usage in humans or animals. These compositions and uses for treating infections could be useful not only for direct treatment or prevention of specific conditions in humans or animals, but also as human or animal food or food supplements, and compositions for treating human or animal waste in an efficient, environmentally friendly, and cost-effective manner.

A novel endophytic fungus, Muscodor albus, was isolated from Cinnamomum zeylanicum and shown to possess the rare capability of having wide antimicrobial activity mainly associated with its gas phase. This organism, in pure culture, produced more than two dozen volatile organic compounds (VOCs) and these were demonstrated, in half moon agar Petri plate assays, to be responsible for the bioactivity of this endophyte. That the VOCs were responsible for the antimicrobial activity was further demonstrated by acquiring the majority of the individual VOCs, placing them in a mixture in the same relative molar ratio that they were detected by gas chromatography/mass spectroscopy (GC/MS), and then testing their activity against a range of pathogenic fungi and bacteria. Interestingly, the artificial mixture virtually mimicked the activity of the fungus itself. Subsequently, individual compounds, combinations of two compounds and three compounds were tested against a range of target microorganisms in order to learn which were necessary to provide the greatest antimicrobial activity. It was demonstrated that central to the bioactivity of the VOCs, and usually produced in the greatest amount in culture, was a small molecular weight organic acid, isobutyric acid, which, by itself, possessed some limited bioactivity both in gas and minimum inhibitory concentration (MIC) assays. However, when placed with one or more complex esters, having little or no activity depending upon the target organism, the mixture was greatly increased in its antimicrobial activity and the concept of synergism could be used to define the effect; i.e., the activity observed was greater than that of either the acid or the esters alone.

Ultimately, it was learned that a mixture of a particular acid and a specific ester placed in an electrolyte solution was extremely effective in treating calves and other animals suffering with diarrhea (i.e., “scours”). The acid in this case was propionic acid and/or isobutyric acid, along with isoamyl hexanoates, having been substituted for any number of other esters made by Muscodor sp, and this was designated “Sx”. These substitutions were inspired by the bioactive formulae of the Muscodor sp.; however, the Sx formulation is not identical to any Muscodor components. It was also observed that Sx was biologically active against a wide range of both human and plant pathogenic fungi and bacteria, including such microbes as Listeria sp., Salmonella sp., drug resistant Staphylococcus aureus, Clostridium sp., Xanthomonas sp. Candida albicans, Pythium ultimum, and Rhizoctonia solani. Thus, while the Sx had been demonstrated to be active against both bacteria and fungi, there had been no indication that Sx would inactivate any virus until the Porcine Epidemic Diarrhea (PED) virus outbreak in pigs in the United States in 2013-2014.

In Montana, one grower lost 850 piglets within a few weeks once the virus reached his locale. The disease was confirmed by Newport Labs of Worthington, MN. The Sx electrolyte solution was administered to tens of animals suffering with PED symptoms. Many of the treated animals seemed better within 5 hours, and all were completely recovered within 24 hours. Post infection assays revealed that no PED virus was lingering in any of the animals that were treated. The PED virus is a coronavirus, thus investigation of whether or not Sx could be used to treat SARS-CoV-2 is of great interest. It is estimated that 20% of COVID-19 patients suffer from severe diarrhea, thus there is potential for treatment of COVID-19 using Sx, as it has proven effective generally against a similar coronavirus, and specifically against a similar condition.

Of additional concern is acute gastroenteritis, which is a diarrheal disease with rapid onset, potentially accompanied by nausea, vomiting, fever or abdominal pain. Diarrhea and other gastrointestinal symptoms often cause dehydration, which can be especially dangerous in infants and small children. Acute gastroenteritis is a common infection impacting both developed and developing nations. Acute gastroenteritis may be caused by a variety of pathogens, including bacteria, viruses, and select parasites. Viruses are widely regarded as the type of pathogen most frequently involved in acute gastroenteritis. Viruses commonly implicated in acute gastroenteritis include norovirus, rotavirus, astrovirus, and adenovirus strains. Norovirus infections are most frequently associated with viral gastroenteritis.

In addition to viral causes of acute gastroenteritis, bacteria may also be responsible for infection. While several bacteria strains may cause acute gastroenteritis, campylobacter, Salmonella, and shigella are most commonly involved in the condition. Lastly, certain parasitic species, including giardia and Cryptosporidium, may cause acute gastroenteritis.

Given the relatively mild symptomology of acute gastroenteritis, treatment is often limited to addressing symptoms and replenishing fluids. However, prevention of acute gastroenteritis is of large concern, particularly among infants and young children where infection may be particularly dangerous. To date, two rotavirus vaccines have been approved to treat infants, namely, RotaTeq, manufactured by Merck, was approved in 2006 for prevention of rotavirus gastroenteritis caused by types G1, G2, G3 and G4. RotaTeq is given as a three-time dosing regimen at 2, 4 and 6 months of age. Rotarix, manufactured by GSK, is also available. Approved in 2008, Rotarix is indicated to prevent rotavirus gastroenteritis caused by G1, G3, G4 and G9 types, with doses given at 2 and 4 months of age. Efficacy for both vaccines is estimated at 60-90%. No vaccines have been approved for norovirus, though there are several vaccine candidates under consideration.

In addition to the risk of severe symptoms or death, acute gastroenteritis also has a substantial economic impact. In the U.S., acute gastroenteritis is estimated to cost at least $250 million in direct medical costs, with more than $1 billion total cost to society. Direct costs are likely due, primarily, to hospitalization costs for young children, while indirect costs are driven by lost productivity.

On a global scale, the direct and indirect costs are more difficult to measure, as per patient costs may vary widely by country. However, norovirus alone is estimated to cause $4.2 billion in direct health system costs and $60.3 billion in societal costs. Given the economic burden of norovirus, the most common cause of acute gastroenteritis as a reference point, it is clear that the global cost of acute gastroenteritis is significant.

A way to reduce the global costs caused by these pathogens is the development of safe and easily available products with different modes of action than antibiotics. These types of in products could be used to treat or prevent acute gastroenteritis disease by reducing the pathogenic contamination throughout the food chain or to provide alternatives to treat gastrointestinal diseases.

In addition to pathogens listed previously, coronaviruses have been known to cause acute gastroenteritis. An underrecognized hallmark of SARS-CoV-2 are gastrointestinal symptoms that may include acute gastroenteritis. Unfortunately, the availability of a SARS-COV-2 vaccine is unlikely to immediately remedy the worldwide pandemic. Thus, it remains imperative to have effective treatments for SARS-CoV-2. Thus, a composition and method for treating infections and solving the aforementioned problems are desired.

### SUMMARY

The composition with antimicrobial properties as well as anti-parasitic, anti-protozoan, and anti-fungal properties comprises isoamyl hexanoates and at least one organic acid component. The at least one organic acid component may be lactic acid, propionic acid, isobutyric acid, butyric acid, lactic acid, formic acid, acetic acid, citric acid, oxalic acid, uric acid, malic acid, tartaric acid or combinations thereof. In some embodiments, the composition further comprises an additional ingredient selected from the group consisting of: peracetic acid, lecithin, and a combination thereof. The composition may be provided in any suitable form, including, but not limited to, a cream, an ointment, a rinse, an oil, a scrub, a spray, a shampoo, a gel, a plaster, a solution, a suspension, a dip, a salve, a powder or granules, or a gas or gas phase. Accordingly, the composition may further comprise additives or carriers.

In some embodiments, the composition comprises isoamyl hexanoates and propionic acid. In some aspects, the volume ratio of the propionic acid to the isoamyl hexanoates is 7:2. In some implementations, the composition further comprises lecithin as the additional ingredient. In such embodiments, the volume % of lecithin is 0.02%. In other implementations, the composition further comprises peracetic acid as the additional ingredient.

Uses of the above-described compositions include reducing microbial contamination (for example, Salmonella contamination) of raw animal tissue during meat processing for preparation of food products or inhibiting microbial growth on raw animal tissue. The method comprise administering of an effective amount of a composition of claim 1 to the raw animal tissue. In particular implementations, the composition administered to the raw animal tissue comprises a mixture (typically aqueous) of the propionic acid and the isoamyl hexanoates at volume ratio of 7:2, wherein the volume percent of the mixture is 1.25-2.5% and the volume percent of lecithin is 0.02%.

Other uses of the disclosed composition include reducing and/or preventing odor in an animal housing. The method comprises administering to a surface in the animal housing a composition comprising an organic acid component and isoamyl hexanoates. In some implementations, the surface in the animal housing is bedding material or a litter box. In some aspects, the compositions for use in reducing odor in animal housing are formulated as a liquid spray or granules for application or addition to a base bedding or litter material. Accordingly, in some aspects, an odor-controlling bedding composition is described, wherein the composition comprises an animal bedding material, isoamyl hexanoates, and at least one organic acid component.

The foregoing and other aspects, features, and advantages will be apparent from the DESCRIPTION and DRAWINGS, and from the CLAIMS if any are included.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Implementations will hereinafter be described in conjunction with the appended and/or included DRAWINGS, where like designations denote like elements, and:

FIG. 1 is an image of the plate 9-Log, 8-Log and 7-Log titers serially diluted Salmonella typhimurium on XLT4 agar;

FIG. 2 is a graph of the Most Probable Number of Salmonella counts per mL of rinsate;

FIG. 3 is an image of XLT4 agar plate replicates from each treatment group for enumeration of Salmonella typhimurium counts from wing wash rinsate.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices, and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The composition described herein have antibacterial, antiparasitic, antiprotozoal, antifungal and antiviral properties and are useful for a variety of uses, for example, as a treatment for wound care, as a food or food supplement, or as a treatment of human or animal tissue and/or waste. The composition comprises isoamyl hexanoates and at least one organic acid component. The isoamyl hexanoates is commercially available, typically as a mix of isomers in a 99:1 ratio of the 3 isomer to the 2 isomer. The at least one organic acid component may be selected from the group consisting of lactic acid, propionic acid, isobutyric acid, butyric acid, lactic acid, formic acid, acetic acid, citric acid, oxalic acid, uric acid, malic acid, and tartaric acid.

In some aspects, the composition comprises the isoamyl hexanoates and the at least one organic acid component in a molar ratio of 1:8 to 1:10 or in a volume ratio of about 2:7. Where more than one organic acid component is part of the composition, the volume ratio of the total volume of the organic acid component to the isoamyl hexanoates is 7:2. In some aspects, the volume ratio of each of the organic acid component is 1:1. For example, where the composition comprises propionic acid and isobutyric acid as the organic acid component, they are at a 50:50 v/v proportion. Thus, in combination with isoamyl hexanoates, the relative proportions in some embodiment of the composition with two organic acid components, is 3.5:3.5:2 v/v/v, acid:acid:ester.

A preferred embodiment is a composition, hereinafter called the “Sx” composition, which includes a 7:2 by volume mixture of propionic acid and isoamyl hexanoates. This mixture corresponds to a molar ratio of 8.83:1 (8.83 moles of propionic acid per mole of isoamyl hexanoates). Table 1 depicts an exemplary recipe for preparing the Sx composition, where the table provides the key components of the Sx composition.

TABLE 1

| Component | Final Concentration |
|---|---|
| Propionic acid | 7.7 mg/mL |
| Isoamyl hexanoates | 2.0 mg/mL |
| ** 99% 3-methyl butyl hexanoate and | |
| 1% 2-methyl butyl hexanoate | |
| RO/DI water | QS to final volume of 1 mL |

In some implementations, the composition further comprises an additional ingredient selected from the group consisting of: peracetic acid, lecithin, and a combination thereof. In some aspects, the volume % of lecithin in the composition is 0.01-0.3%, 0.01-0.05%, 0.01-0.04%, 0.02-0.3%, 0.02-0.05%, 0.02-0.04%, or about 0.02%. In a particular embodiment, the composition comprises a mixture of the organic acid component and the isoamyl hexanoates at a volume ratio of 7:2 with lecithin. In such a composition, the volume percent of the mixture of the organic acid component and the isoamyl hexanoates is 1.25-2.5% and the volume percent of lecithin is 0.02%.

Depending on the use and intended mode of delivery, the composition may include or be added to other components, e.g., flavors, excipients, nutritional supplements, etc.

The composition may be provided in any suitable form, including, but not limited to, a cream, an ointment, a rinse, an oil, a scrub, a spray, a shampoo, a gel, a plaster, a solution, a suspension, a dip, a salve, an ear rinse, a powder or granules, an eyewash, mouthwash, a nail lacquer, a gas or gas phase. It should be understood that any suitable type of carrier may be used to administer the composition. As a non-limiting example, a molecular sieve may be used to adsorb and then desorb to administer the composition.

In one aspect, the disclosed composition is useful for reducing contamination of raw animal tissue (such as carcasses or parts being processed for human food consumption) or of raw eggs and other animal-derived foodstuffs; reducing microbial growth on raw animal tissue, eggs, or other animal-derived foodstuffs; reducing odor in an animal housing; and preventing odor in an animal housing. The compositions provide these benefits without being, or needing, a traditional “antibiotic.” In use, an effective amount of the composition is administered to the raw animal tissue or to a surface in the animal housing.

Non-limiting examples of contaminations that can be reduced are fungal contamination, protozoa contamination, bacterial contamination, parasitic contamination, viral contamination. Contamination sources that can be inhibited include, but are not limited to Salmonella enterica, Streptomyces avermitilis, Cercospora beticola, Phytophthora cinnamomic, Verticillium dahlia, Sclerotinia sclerotiorum, Pythium ultimum, Fusarium subglutinans, Trichoderma viridae, Rhizoctonia solani, Aspergillus fumigatus, Candida albicans, Escherichia coli, Bacillus subtilis, and Saccharomyces cerevisiae. The concentration of the composition used to reduce contamination on raw animal tissue, eggs, or other animal-derived foodstuffs (such as a carcass wash), comprises at least one organic acid component, isoamyl hexanoates, and an additional ingredient selected from lecithin, peracetic acid, or a combination thereof. In some embodiments, the volume % of lecithin in the composition is 0.01-0.3%, 0.01-0.05%, 0.01-0.04%, 0.02-0.3%, 0.02-0.05%, 0.02-0.04%, or about 0.02%. In a particular embodiment, the composition comprises a mixture of the organic acid component and the isoamyl hexanoates at a volume ratio of 7:2 with lecithin. In such a composition, the volume percent of the mixture of the organic acid component and the isoamyl hexanoates is 1.25-2.5% and the volume percent of lecithin is 0.02%. In some aspects, the composition further comprises a carrier such as water.

The composition for use in odor reduction comprises at least one organic acid component, isoamyl hexanoates, and bedding or litter material. In some aspects, the organic acid component and the isoamyl hexanoates are a mixture that is applied to the applied or mixed into the bedding or litter material. Animal bedding material that can be treated and thus used in the composition include, but are not limited to straw, wood shavings, wood pellets, sawdust, sand, wood chips, paper, clay, and silica. In some aspects, the mixture of the organic acid component and the isoamyl hexanoates at a volume ratio of 7:2 with lecithin. In some implementations, the volume percent of the mixture of the organic acid component and the isoamyl hexanoates is 1.25-2.5% and the volume percent of lecithin is 0.02%. In some embodiment, a ratio of 3 ml of the mixture for every pound of bedding or litter box material. In some aspects, the composition for use in odor reduction is a spray comprising the at least one organic acid component and isoamyl hexanoates in a mixture along with a carrier. In such embodiments, the concentration of the mixture in the composition is approximately 1.25%-2.5% by volume.

### Odor Reduction Compositions and Use

To deodorize animal housing, the composition described herein may be used as a treatment of bedding such as in animal stalls, barns, chicken-raising facilities, pig barns, pet stations in homes, and zoos, or treatment of litter and/or litter box. An exemplary odor reduction composition comprises an organic acid component, isoamyl hexanoates, and animal bedding material. Animal bedding material that can be treated and thus used in the composition include, but are not limited to straw, wood shavings, wood pellets, sawdust, sand, wood chips, paper, clay, and silica. In another exemplary implementation, a method of reducing odor comprises administering Sx composition or a similar mixture to zeolite, for example at a rate of about 31b of material per 400 square feet of coverage in a stall, or 90 ml of Sx per 3 lbs of zeolite.

As a further non-limiting example, the Sx composition or similar mixture may be incorporated into litter, such as that in a poultry facility. As this treatment also results in reducing ammonia levels in the surrounding environment, the birds are expected to exhibit both weight gain and feed efficiency.

In order to test the Sx mixture for this purpose, it is proposed to test the Sx mixture on 315 one-day old (at the start of the testing) Cobb500 broilers. The broilers will be individually identified with plastic neck tags and will be housed in floor pens within three different rooms in the poultry building. For example, each room could contain three floor pens, with one treatment per room. Each floor pen may measure, for example, approximately 5′×7.5′, providing approximately 1 square foot of surface area per bird. Used rice hull bedding, approximately 3-4″ deep, will be used in each pen.

Temperatures and humidity will be monitored using electronic meters placed in each floor pen. The initial temperature in each floor pen will be maintained at approximately 85° F. using heat lamps and a ventilation system. Temperatures will be reduced approximately 0.5° F. per day until the temperature reaches approximately 75° F. Humidity will be maintained in each room at approximately 50-70% using the heat lamps and ventilation system. The birds will be fed a commercial ration and will be provided with water according to facility standard operating procedures.

Further, no concomitant medications will be used during the duration of the study. All birds to be enrolled in the study will be free of clinically observable abnormalities. Birds exhibiting clinically apparent abnormalities prior to the test will be excluded from enrollment in the study. The study is proposed to be a completely randomized trial, with 105 birds being a “negative control” with no litter treatment, 105 birds being a “positive control” with a commercially available poultry litter treatment (PLT®-Poultry Litter Treatment, manufactured by the Jones-Hamilton Co.), and 105 birds using the Sx mixture-treated poultry litter.

During the testing, the litter in negative control floor pens will not be treated with any product. The positive control floor pens will be treated with the PLT®-Poultry Litter Treatment by applying 3.5 lbs. of the product to the surface of the litter in each pen using a handheld broadcast spreader. The positive control product should not be incorporated into the litter. The Sx mixture-treated poultry litter floor pens will be treated with the Sx mixture-treated poultry litter by applying 0.2 lbs. of the Sx mixture-treated poultry litter to the surface of the litter in each pen using a handheld broadcast spreader. The Sx mixture-treated poultry litter also will not be incorporated into the litter. Both the positive control product and the Sx mixture-treated poultry litter will be applied to the litter approximately 24 hours prior to placing the broilers in the pens.

During testing, temperatures at bird level in each floor pen will be monitored with electronic thermometers. Temperatures will be recorded at 8 AM, 12 PM, 4 PM and 8 PM daily on days 1-14. Humidity at bird level in each floor pen will be monitored with electronic meters. Humidity also will be recorded at 8 AM, 12 PM, 4 PM and 8 PM daily on days 1-14. Ammonia levels at bird level in each floor pen will be monitored with electronic meters. Ammonia levels also will be recorded at 8 AM, 12 PM, 4 PM and 8 PM daily on days 1-14. Daily pen feed consumption will be based upon the difference in feed offered and feed weighbacks recorded on days 1-14. Individual bird bodyweights will be recorded on days 1 and 14 to assess weight gain over the course of the study.

The primary variable that will be used to determine efficacy of the Sx mixture-treated poultry litter will be the ammonia levels in the Sx mixture-treated pens vs. the negative and positive controls. Mean daily humidity levels and ammonia levels per pen will be analyzed using repeated measures analysis of variance. Differences between treatment groups in weight gain and feed efficiency over the 14-day duration of the study will be analyzed by Student's T-test. Differences in the incidence of mortalities per treatment group will be analyzed using Fisher's Exact test. Analyses will be performed using Graphpad Prism 8™ software on a Macintosh® computer. Given the small number of animals involved, the level of significance is set to α=0.1 for the statistical analysis of all parameters.

### Carcass Treatment Composition and Use

As a non-limiting example, the efficacy of Sx on the reduction of nalidixic acid-resistant Salmonella spp. on experimentally contaminated broiler carcasses (using a wing wash model) was tested. Sx was tested at 100 ppm and 200 ppm, with or without lecithin and was compared with an untreated negative control group and peracetic Acid (PAA) at 200 ppm as a commercial comparator. Previous studies conducted at this site had demonstrated effectiveness of Sx at various levels when compared to control groups. Almost 0.6 to 3.0 log reduction has been observed in previous iterations. During those studies, the effectiveness of Sx was studied at different time intervals and fixed time interval. It was noted that there was no significant difference in salmonella reduction between different time intervals. Hence, 15 minutes incubation has been considered for all future studies. Whereas, based on literature and food safety inspection services (USDA) directive 7120.1, PAA has been recommended with the dose range of 50 ppm to 2000 ppm. Under field conditions, most of the establishments use 200 ppm as a whole carcass rinse. Therefore, in this iteration, Sx was compared with PAA at 200 ppm level. In this study, Sx was tested at 1.25% and 2.5% level which are equivalent to 100 ppm and 200 ppm of propionic acid concentration. Lecithin was added to the Sx solution at the rate of 0.02%. Lecithin is believed to enhance the cell wall penetration of propionic acid and isoamyl hexanoate leading to better antimicrobial activity.

For this study, a WHIRL-PAK® bag containing one pair of chicken wings was the experimental unit. On approximately day 47 of the broilers age, approximately 54 broilers were euthanized by severing the jugular vein after euthanization. The carcass was thoroughly washed using hot water. The feathers were removed using a mechanical plucker. The wings were separated from the whole carcass and preserved in a cooler containing ice. There were six treatment groups as shown in the Table 2 below. Each treatment group was represented by nine sample bags (replicates) containing one pair of wings. Three sample bags from each treatment group were pooled together and identified as first, second and third set as shown in Table 3.

TABLE 2
Treatment Groups

| | | Salmonella | | | |
|---|---|---|---|---|---|
| | | Enterica | | | |
| | | serovar | | | # of |
| | | Typhimurium | | | Wings |
| Treat- | | challenge | Incu- | # of | per |
| ment | Treatment | (1 × 10⁸ | bation | Repli- | Repli- |
| Code | Group | cfu/mL) | time | cates | cate |
| T1 | Non-medicated | Yes | 15 mins | 9 | One pair |
| | challenged | | | | |
| T2 | Sx 1.25% | Yes | 15 mins | 9 | One pair |
| | medicated, | | | | |
| | challenged | | | | |
| T3 | Sx 2.50% | Yes | 15 mins | 9 | One pair |
| | medicated, | | | | |
| | challenged | | | | |
| T4 | Sx 1.25% | Yes | 15 mins | 9 | One pair |
| | medicated + | | | | |
| | Lecithin 0.02%, | | | | |
| | challenged | | | | |
| T5 | Sx 2.50% | Yes | 15 mins | 9 | One pair |
| | medicated + | | | | |
| | Lecithin 0.02%, | | | | |
| | challenged | | | | |
| T6 | PAA 200 PPM | Yes | 15 mins | 9 | One pair |
| | medicated, | | | | |
| | challenged | | | | |

Total 54 pairs

To start with, eighteen pairs of wings were brought to the hood and sprayed with Salmonella typhimurium (Nalidixic Acid Resistant [NAR]) inoculum at the rate of 10 mL per pair. The carcasses were allowed to dry for 15 minutes. Following drying, eighteen pairs of wings were inserted into WHIRL-PAK bags at the rate of one pair per WHIRL-PAK bag. T1 bags were added with non-medicated, sterilized reverse osmosis (SRO) water at the rate of one liter per bag. T2-T6 bags were added with respective medicated, SRO water at the rate of one liter per bag. All the bags were incubated for 15 mins in a cooler containing ice cubes. After 15 minutes, the carcass in each bag was removed from the SRO water bag and inserted into a fresh WHIRL-PAK bag.

Approximately 100 mL of buffered peptone water was added into each bag and agitated for one minute. One mL of rinsate was collected in a 2 mL vial and processed with the standard operating procedure of microbiological plating method. After plating, the second set of bags were processed in a similar matter. Upon completion of the second set, the third set of bags were processed in a similar fashion.

After completion of all three sets, plates were placed in the incubator and incubated overnight at 37.5° C.

A nalidixic acid-resistant Salmonella Enterica serovar Typhimurium was used for this study. Frozen culture of a nalidixic acid-resistant strain of Salmonella enterica serovar Typhimurium was streaked onto XLT4 agar supplemented with 30 μL/mL of nalidixic acid and incubated for 24 h at 37.5° C.±1° C. Fresh colonies (2-3) from XLT4 agar was inoculated into 50 mL of tryptic soy broth and incubated for 12-16 h at 37.5° C.±1° C. The 10 mL overnight culture was added to 90 mL of Tryptic soy Broth and incubated for 5 h at 37.5° C.±1° C. After incubation, the mid Log culture was centrifuged at 5,500×g for 10 min, and the pellet was resuspended with 100 mL 1% PBS and this mid-log culture was identified as 9-Log titer. The 60 mL of this suspension (9-Log titer) was added into 540 mL of 1% PBS and this one was identified as 8-Log titer. Similarly, 60 mL of 8-log titer was added to 540 mL of 1% PBS and this one was identified as 7-Log titer.

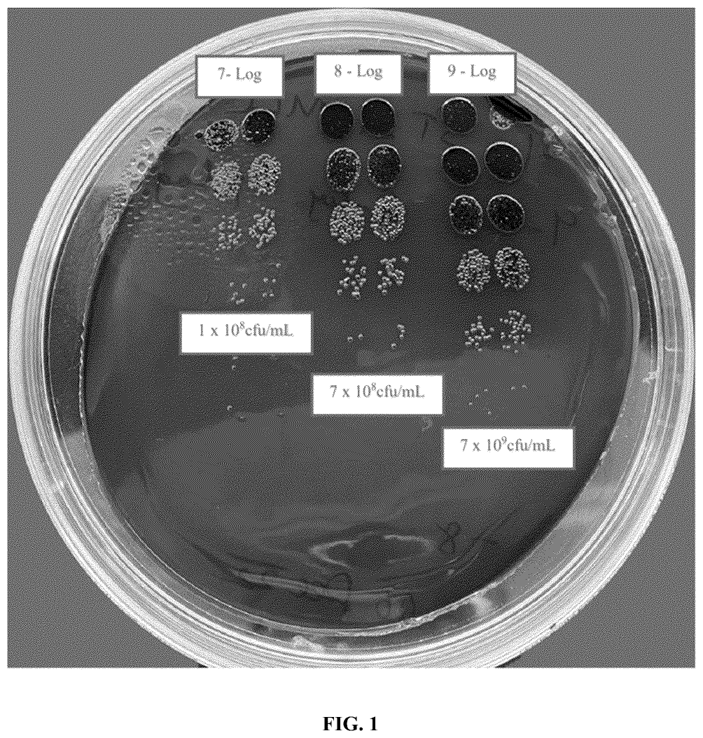

The culture was preserved in the refrigerator until usage. 100 μL of inoculum from 9-Log, 8-Log and 7-Log titers were serially diluted and plated in duplicate using drip method on XLT4 Agar as seen in FIG. 1. The XLT4 agar plate was incubated at 37.5° C.±1° C. for 18-24 h. The typical colonies were counted and enumerated to determine the exact titer values. In this study, 8-Log titer inoculum was used to spray the carcasses. The actual titer value was 8×10⁸ cfu/mL Fresh skin-on broiler chicken wing flats (before any antimicrobial treatment) was obtained on the day of the experiment. Chicken wings were used in this study to present a worst-case scenario as wings are completely covered with skin and can potentially provide protection to microorganisms and prevent exposure to antimicrobial.

The inoculum was sprayed at the rate of 10 mL/pair of wings. After mixing with the 1 liter of RO water (either negative control or medicated water), the number of viable salmonella counts will be 8.0×10⁶ cfu/mL. There were three sets of sprays as shown below:

TABLE 3
Pooled Treatment Groups

| Sets | Bag Numbers | Duration |
|---|---|---|
| First | T1-1, T1-2, T1-3, | 15 minutes |
| Set | T2-1, T2-2, T2-3, | |
| | T3-1, T3-2, T3-3, | |
| | T4-1, T4-2, T4-3, | |
| | T5-1, T5-2, T5-3, | |
| | T6-1, T6-2, T6-3 | |
| Second | T1-4, T1-5, T1-6, | 15 minutes |
| Set | T2-4, T2-5, T2-6, | |
| | T3-4, T3-5, T3-6, T4-4, T4-5, T4-6 | |
| | T5-4, T5-5, T5-6, | |
| | T6-4, T6-5, T6-6 | |
| Third | T1-7, T1-8, T1-9, | 15 minutes |
| Set | T2-7, T2-8, T2-9, | |
| | T3-7, T3-8, T3-9, T4-7, T4-8, T4-9, | |
| | T5-7, T5-8, T5-9, | |
| | T6-7, T6-8, T6-9 | |

For each replication, one pair of chicken wings were spray inoculated with 10 mL of inoculum containing resistant strains of Salmonella enterica serovar Typhimurium (ca. 8 log 10 cfu/mL) in a laminar flow biological safety cabinet. The inoculated wings were placed in a biological safety cabinet for 15 min to allow bacterial attachment at room temperature.

To prepare the medicated stock solution, approximately 54 liters of sterilized, cold, reverse osmosis (RO) water were obtained. Six buckets were identified and marked as shown in Table 2.

For T2 and T3 water buckets, Sx was drawn and added to the respective buckets at the recommended level as shown in the Table 4. For Treatment group T4, 112.5 mL of Sx was mixed with Lecithin at the rate of 1.8 mL and mixed thoroughly and added to the T4 bucket. Similarly, for T5 treatment group, 225 mL Sx was mixed with 1.8 mL of Lecithin and added to the T5 bucket. For the T6 treatment group, 32 mL of Peracetic Acid was added to provide 200 ppm concentration.

TABLE 4
Sx Levels Per Treatment Group

| Treatment | | SRO | Product |
|---|---|---|---|
| Group | Product | water | requirement |
| T2 | Sx 1.25% (100 ppm) | 9 Liters | 112.5 mL |
| T3 | Sx 2.50% (200 ppm) | 9 Liters | 225 mL |
| T4 | Sx 1.25% + Lecithin | 9 Liters | 112.5 mL (Sx) + 1.8 mL |
| | 0.02% | | (Lecithin) |
| T5 | Sx 2.50% + Lecithin | 9 Liters | 250 mL (Sx) + 1.8 mL |
| | 0.02% | | (Lecithin) |
| T6 | PAA 200 ppm | 9 Liters | 32 mL |

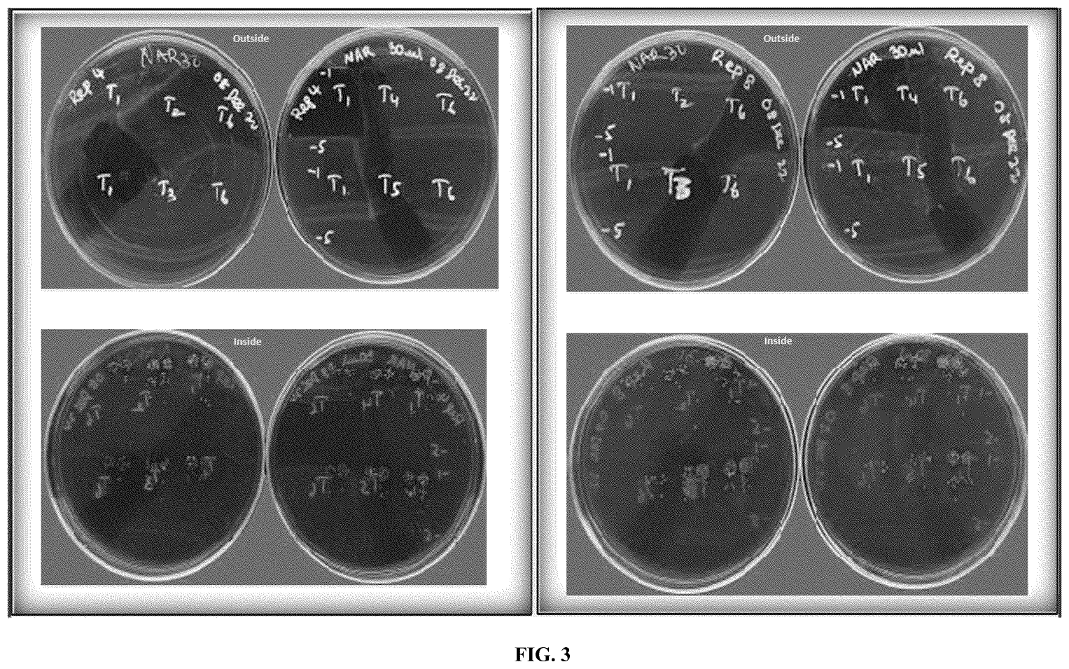

After treatment, the wings were aseptically removed and placed in new sterile bags and rinsed with 100 mL buffered peptone water with 0.1% sodium thiosulphate. Rinsing was performed by vigorous shaking of the samples for 1 min to recover bacterial cells from the wing flats. Rinsates from each sample (1 mL) was collected in a 2 mL vial and serially diluted with 1% PBS. For Salmonella enumeration, appropriate serial dilutions was prepared with PBS and was plated in duplicate on XLT4 30 μL/mL Nalidixic acid plates and incubated at 37.5° C. for 18-24 hrs (FIG. 3). Typical Salmonella colonies were counted and reported as log 10 cfu/mL.

The data was analyzed using One-way ANOVA in the GLM of SAS (JMP 16.2, Cary, NC). Statistical differences between the treatments will be reported as least square means, and significance was reported at a level of P<0.05 (SAS Institute, 2004).

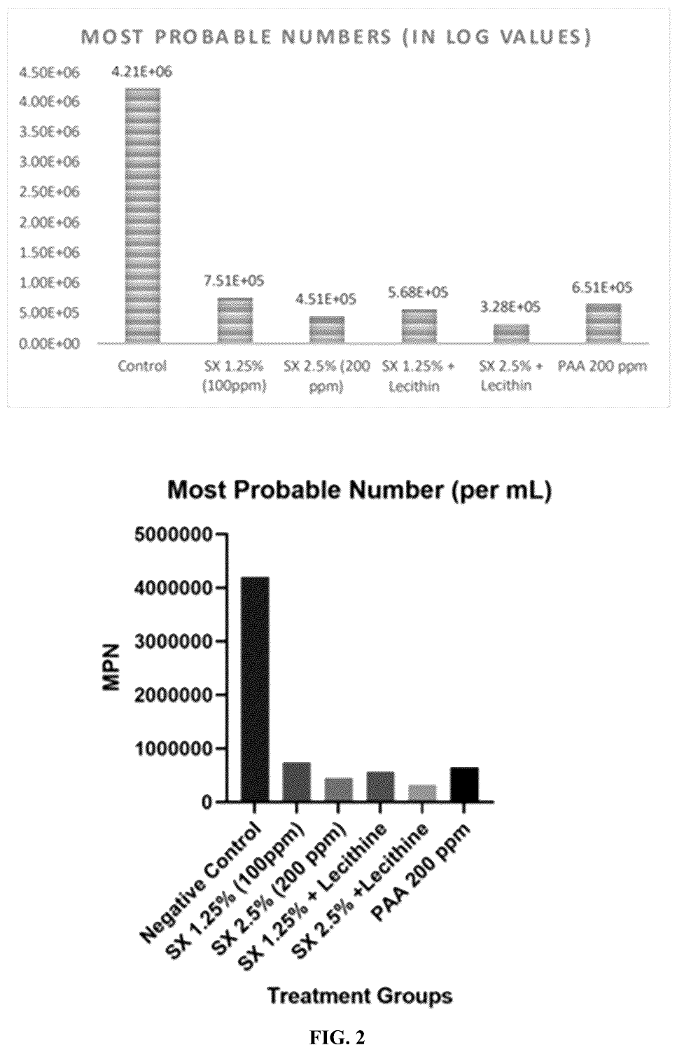

Results from the wing wash rinsate test are summarized in Table 5. Negative control samples exhibited consistently higher counts in all three sets. The average count of negative control group was 4.21×10⁶ cful/mL±5.97E+06. Sx at 100 ppm and 200 ppm concentration showed a statistically significant (P<0.05) decrease of 82% (7.51E+05±4.74E+05) and 89% (4.51E+05±4.29E+05) respectively. Sx at 100 ppm and 200 ppm concentration with lecithin also had a statistically significant (P<0.05) decrease of 86% (5.68E+05±6.01E+05) and 92% (3.28E+05±3.11E+05) respectively when compared to the untreated control. PAA at 200 ppm (positive control) had a statistically significant (P<0.05) decrease of 84% (6.51E+05±5.68E+05). Sx 200 ppm with lecithin was the leading candidate showing the greatest reduction among all treatment groups when compared to the untreated control. Overall reduction of salmonella count was 0.67 Log, 0.97 Log, 0.85 Log, 1.09 Log and 0.77 Log for Sx 100 ppm, Sx 200 ppm, Sx 100 ppm+Lecithin, Sx 200 ppm+Lecithin and PAA 200 ppm respectively as shown in FIG. 2. In general, Sx 200 ppm with or without lecithin showed greater reduction in counts when compared to Sx 100 ppm with or without lecithin and PAA 200 ppm. Sx with lecithin at 100 ppm and 200 ppm level showed a 0.2 and 0.32 Log reduction when compared PAA 200 ppm. Whereas Sx without lecithin at 200 ppm had similar counts when compared to PAA 200 ppm.

TABLE 5
Results from the wing wash rinsate test

| | | MPN (in | | MPN | | | |
|---|---|---|---|---|---|---|---|
| | | Log | Std. | (Actual | MPN | % | Log |
| Treatment Group | | values) | Dev | numbers) | reduction | Reduction | Reduction |
| T1 | Control | 4.21E+06 | 5.97E+06 | 4,211,111 | — | — | |
| T2 | Sx 1.25% | 7.51E+05 | 4.74E+05 | 751,111 | 3,460,000 | 82.16 | 0.67 |
| | (100 ppm) | | | | | | Log |
| T3 | Sx 2.5% | 4.51E+05 | 4.29E+05 | 450,556 | 3,760,556 | 89.30 | 0.97 |
| | (200 ppm) | | | | | | Log |
| T4 | Sx 1.25% + | 5.68E+05 | 6.01E+05 | 568,333 | 3,642,778 | 86.50 | 0.85 |
| | Lecithin | | | | | | Log |
| T5 | Sx 2.5% + | 3.28E+05 | 3.11E+05 | 328,333 | 3,882,778 | 92.20 | 1.09 |
| | Lecithin | | | | | | Log |
| T6 | PAA 200 | 6.51E+05 | 5.78E+05 | 650,694 | ,560,417 | 84.55 | 0.77 |
| | ppm | | | | | | Log |

P < 0.05

Sx (at 1.25% or 2.5%, with or without lecithin) as a GRAS ingredient product, was either equal to or more effective than PAA 200 ppm in reducing Salmonella contamination in a wing wash model simulating a carcass wash used in poultry processing facilities.

As shown in the results, Sx is a safe and effective antimicrobial effective in controlling Salmonella enteric serovar Typhimurium contamination in experimentally contaminated broiler carcass. The use of lecithin as emulsifier has a significant value in assisting the penetration of Sx through the cell wall.

It is to be understood that the compositions and methods of use, are not limited to the specific embodiments described above but encompass any and all embodiments within the scope of the generic language of the following claims enabled by the embodiments described herein, or otherwise shown in the drawings or described above in terms sufficient to enable one of ordinary skill in the art to make and use the claimed subject matter.

I/We claim:

1. A composition comprising:
an organic acid component;
isoamyl hexanoates; and
an additional ingredient selected from the group consisting of: peracetic acid, lecithin, and a combination thereof.

2. The composition of claim 1, wherein the organic acid component comprises at least one acid selected from the group consisting of propionic acid, lactic acid, acetic acid, uric acid, malic acid, and tartaric acid.

3. The composition of claim 1, wherein the organic acid component is propionic acid.

4. The composition of claim 3, wherein the volume ratio of the propionic acid to the isoamyl hexanoates is 7:2.

5. The composition of claim 4, wherein the additional ingredient is lecithin.

6. The composition of claim 5, wherein the volume % of lecithin is 0.02%.

7. The composition of claim 4, wherein the additional ingredient is peracetic acid.

8. The composition of claim 4, wherein the additional ingredient is a combination of peracetic acid and lecithin.

9. A method of reducing microbial contamination of raw animal tissue during meat processing for preparation of food products, the method comprising administering of an effective amount of a composition of claim 1 to the raw animal tissue.

10. The method of claim 9, wherein the composition administered to the raw animal tissue comprises propionic acid as the organic acid component and the additional ingredient comprises lecithin.

11. The method of claim 10, wherein the composition comprises a mixture of the propionic acid and the isoamyl hexanoates at volume ratio of 7:2, the volume percent of the mixture in the composition is 1.25-2.5% and the volume percent of lecithin is 0.02%.

12. The method of claim 9, wherein the microbial contamination reduced is Salmonella contamination.

13. The method of claim 9, wherein raw animal tissue is from chicken.

14. An odor-reduction composition comprising:
an organic acid component;
isoamyl hexanoates; and
animal bedding material.

15. The composition of claim 14, wherein the animal bedding material is selected from the group consisting of: straw, wood shavings, wood pellets, sawdust, sand, wood chips, paper, clay, and silica.

16. The composition of claim 14, wherein the organic acid component comprises at least one acid selected from the group consisting of propionic acid, lactic acid, acetic acid, uric acid, malic acid, and tartaric acid.

17. The composition of claim 16, wherein the organic acid component is propionic acid.

18. The composition of claim 17, wherein the volume ratio of the propionic acid to the isoamyl hexanoates is 7:2.

19. A method of preventing or reducing odor in an animal housing, the method comprising administering to a surface in the animal housing a composition comprising:
an organic acid component; and
isoamyl hexanoates.

20. The method of claim 19, wherein:
the organic acid component is propionic acid;
volume ratio of the propionic acid to the isoamyl hexanoates is 7:2; and
the composition is formulated as a liquid spray or granules.
